(19) United States
(12) Patent Application Publication
(10) Pub. No.: US 2010/0112147 A1
(43) Pub. Date: May 6, 2010

(54) Hot Temperature Aerated Dairy Product Having Shelf Stable Properties

(76) Inventors: David John BARNARD, Arlington Heights, IL (US); Alice Shen Cha, Northbrook, IL (US); Richard Harold Lincourt, Mundelein, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/261,767

(22) Filed: Oct. 30, 2008

(51) Int. Cl. A23C 9/00

(52) U.S. Cl. 426/130; 426/392

(57) ABSTRACT

A shelf stable, high moisture hot-aerated dairy product is disclosed that comprises a mixture of about 10 to about 66% of a dairy component, about 20 to about 30% of a fat component, and about 0.5 to about 2.5% of a stabilizer system. The stabilizer system comprises at least a two gum system, where one gum is gelatin, or at least a three gum system, where one gum is either gelatin or carrageenan with the remaining gums being different. The mixture is aerated to about 2% to about 20% overrun while the mixture is still hot and is subsequently filled into packages at the high temperature, i.e., from about 140° F. to about 180° F. The resultant dairy product has a shelf life of at least 12 months when stored at ambient temperatures or at least 18 months when stored at refrigeration temperatures without requiring aseptic processing or packaging techniques.

### FIELD

The present disclosure relates generally to hot-temperature aerated dairy products having shelf stable properties.

### BACKGROUND

It is common for dairy products to be aerated prior to packaging in order to give the dairy product a desirable fluffy, light texture and appearance and a spreadable or dippable texture. However, after aeration, such dairy products cannot readily be made shelf stable. If a dairy product is aerated under, or subsequently treated with, high temperatures, i.e., those temperatures necessary to enable the dairy product and enable it to be shelf stable, the aerated dairy product typically cannot maintain the aerated cell structure. Therefore, aeration of dairy products typically is carried out at lower temperatures, i.e., temperatures that do not aseptically treat the dairy product, and thus will subsequently require more costly aseptic packaging in order to maintain a reasonable shelf-stability of the product. In these cases, unless the dairy products are first treated with high temperatures prior to aeration at lower temperatures and maintained under strictly sterile conditions until packaged, they cannot be considered shelf stable.

Therefore, manufacturing a shelf stable dairy product having an acceptable aerated texture is typically only possible where the dairy product has a low water activity (i.e., Aw less than 0.85, which often produces a firm, chewy, undesirable texture) or if the dairy product is aerated after first heat processing and cooling to moderate temperatures (e.g., <100° F.), followed by aseptic filling in hermetically sealed packaging—usually a very costly process and packaging combination. Without these functional and/or processing parameters, the aerated dairy products often require refrigerated storage and, even then, they often have relatively short shelf lives.

Commercially available whipped and/or aerated cream cheeses are usually not shelf stable. Attempts to fill and package often at high temperatures results in significant damage to the desired aerated structure. Therefore, commercially whipped and/or aerated cream cheese products are aerated at lower temperatures and cooled before packaging.

U.S. Pat. No. 6,503,553 discloses a processed dairy product that is first aerated while at a cold temperature (i.e., about 4° C.) and is then mixed with a hot (greater than 48° C. (118° F.)) aqueous gelatin solution. Upon mixing, the dairy product, i.e., creamy base component, is substantially deaerated before or during addition of further food components such as the gelatin. Only this deaerated form of the processed dairy product provides a stable product which can be frozen for long term storage. The resulting processed dairy product requires storage under refrigeration or frozen conditions; moreover, it is deaerated.

Some dairy based products can be manufactured with various additives and stabilizers. International Publication No. WO 2004/016094 discloses a frozen dessert composition with an added starch hydrolysate to impart heat shock resistance and maintain good taste and texture. Some formulations may include stabilizing gums to assist in heat shock resistance; such stabilizing gums (up to about 0.2%) can result in an unacceptable gummy mouth feel and also tend to make the final composition firmer than desired. Aeration occurs only after pasteurization, homogenization, and cooling to about 4° C. These are not shelf stable and require frozen storage to maintain the aerated cell structure for any appreciable time.

Typically, when stabilizers are used in dairy products the amount added to the resulting product must be adjusted carefully or else the final texture and consistency does not resemble the food product desired. For instance, if too much stabilizer is added, then a chewy and/or rubbery texture is obtained. If not enough stabilizer is used, then the texture cannot hold aeration well. Furthermore, syneresis can occur, where the aerated product is too soft at room temperature, causing water or other liquids to leach from the dairy product.

A dairy product, such as a cappuccino, suitable for frothing by mechanical means, is disclosed in European Patent Application No. 1329162. The resulting cappuccino drink has a froth or foam at its upper surface. The cappuccino drink contains customary milk components (i.e., skimmed, semi-skimmed, full fat milk) plus 0.3-2% hydrolysed milk protein. The dairy product can be prepared using a dried or concentrated dairy product that is reconstituted with water; the reconstituted product is suitable for frothing by mechanical means (i.e., shear forces or by application of a propellant gas). Due to the nature of the product the froth formed only needs to last long enough for the drink to be consumed. Additionally, the dairy product can contain less than 1% of certain gums and less than 2% of oligosaccharides or polysaccharides as fat substitutes, such as inulin or carrageenan.

Thus, there remains a need for high temperature treated aerated dairy products having shelf stability and a stable aerated structure. This invention provides such products.

### SUMMARY

A high moisture dairy product and method of making the high moisture dairy product is disclosed. The high moisture dairy product can be aerated and packaged at high temperatures (i.e., greater than about 140° F.) while still maintaining the aerated cell structure. The high moisture dairy products comprise a dairy food base, a fat, and a hydrocolloid stabilizing system. More specifically, unique blends of hydrocolloids that contain at least two gums, one of which is gelatin, or at least three gums, one of which is either gelatin or carrageenan, can be used which can maintain the aerated structure of the high moisture dairy product at high temperatures; this allows for the production of shelf stable product or products with very long refrigerated shelf lives, without the need for costly aseptic filling and packaging.

For instance, the high moisture shelf stable dairy product can comprise about 10 to about 66% dairy food base, about 20 to about 30% fat, and about 0.5 to about 2.5% hydrocolloid stabilizing system. The dairy food product can be aerated to about 2% to about 20% overrun at temperatures of about 140° F. or higher, preferably 150° F. or higher. The aerated dairy mixture or product can be treated at high temperatures without adversely effecting the aerated structure. The fat further comprises a high melting point fat at about 4.25% to about 20% of the total fat content. The hydrocolloid stabilizer system can comprise a blend of at least two gums one being gelatin, or a blend of three or more gums, one being either gelatin or carrageenan.

The high moisture dairy products of the present invention, using a blend of hydrocolloid-based stabilizing ingredients, have sufficient viscosity to maintain the aerated structure in the high moisture dairy food at high temperatures. The hydrocolloid stabilizing system is stable at low pH conditions (i.e., about 3.7 to about 4.6) and can be aerated at high temperatures; the aerated structure is maintained at high temperatures and then upon cooling and during storage. Upon cooling, the high moisture dairy products do not become excessively viscous or gummy. These dairy foods can be aerated and then processed and packaged at high temperatures resulting in shelf stability at low cost, and still supply pleasant eating qualities upon cooling. Furthermore, the hot-aerated and hot-filled dairy products do not require costly aseptic processing and packaging, as do shelf stable products which are aerated at moderate or low temperatures before packaging. The hot-aerated dairy products are shelf stable at ambient temperature and do not require refrigeration. These dairy products are ideally suited for use as on-the-go snacks. Moreover, they are ideally suited for use in areas where refrigeration is not available and/or unreliable.

### BRIEF DESCRIPTION OF THE DRAWINGS

FIG. 1 provides a schematic flow diagram of a general method of making an aerated and shelf stable cream cheese product.

### DETAILED DESCRIPTION

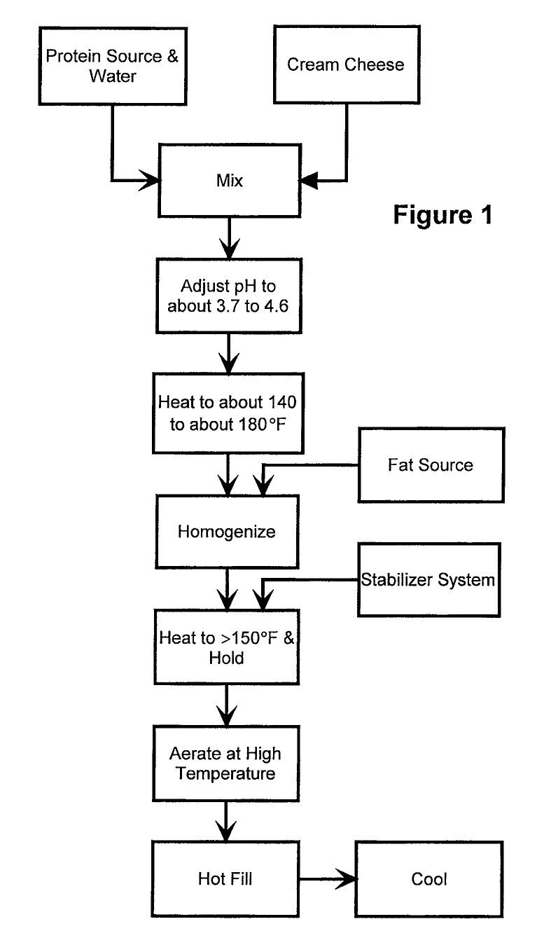

Shelf stable, aerated dairy products and methods of manufacture are provided. The dairy products comprise a dairy food base, a fat, and a hydrocolloid stabilizing system which can be collectively aerated at high temperatures (i.e., greater than about 140° F.), and hot-filled into its respective packaging. The general method of this invention is illustrated in FIG. 1. In particular, the hydrocolloid stabilizer system can comprise at least a two gum blend. For a two gum blend, one gum is gelatin. In a three or more gum blend, one gum is either gelatin or carrageenan. The stabilizer helps to impart stability to the aerated dairy product, thus aiding in maintaining its aerated structure even at high temperatures. The level of aeration can be measured at about 2% to about 20% overrun. Furthermore, the fat includes a high melting point fat (having a melting point of about 100° F. to about 110° F.) to aid in the stability of the aerated structure and resulting shelf stability. Additionally, the final product is easily “scoopable” such that it can easily be removed or scooped from the package using, for example, a spoon or cracker. The dairy product that results is shelf stable, i.e., does not require refrigeration or freezing, and does not require any type of aseptic packaging techniques upon hot-filling the packages after aeration at high temperatures.

“Overrun” refers to the increase in volume of the aerated product, and also is referred to as foaming capacity. It is measured according to the following equation: (volume of the food after aeration—volume of the food before aeration)/(volume of the food before aeration). It is reported as a percentage value. “Aerated” refers to the incorporation of a gas into a food material. For purposes herein, the gas is not particularly limited, and may be air, nitrogen, carbon dioxide, nitrous oxide, gas combinations, and so forth.

The dairy component can comprise a dairy based food component, such as cream cheese. In one aspect, a cream cheese can be used that has not been aerated yet and can be provided in amounts between about 10 and about 66% by weight. In another aspect, a cream cheese that has not been aerated yet but may comprise a gum or other stabilizer can be used, however, typically such gums would be in amounts less than about 1%. In yet another aspect, a cream cheese curd can be used after the separation from the whey component, but before addition of any stabilizers such that an unstabilized cream cheese component can be used as the dairy base component. Where cream cheese is used as the dairy component it can be preferable to add approximately 30-35% to the mixture, however, up to about 66% can be added. The cream cheese component can comprise a full fat or light cream cheese. The amount of the dairy component is important to maintain a good level of protein and fat in the final product which can contribute to the final smooth and airy texture of the product. However, too much of the dairy component (i.e., >66%) may give a dairy fat level that is too high, especially where the dairy fat comprises mainly a low-melting point fat, so that it cannot hold air cells well in the matrix during cooling. Further, too high of a dairy component may also provide a very high lactose level that can result in lactose crystals which give a sandy texture to the final product.

The fat source can be provided in a total amount between about 20% to about 30% by weight. The fat source can be selected from the group comprising cream cheese (i.e., full fat or low fat cream cheese), coconut oil, palm oil, hydrogenated soybean oil, hydrogenated palm kernel oil, or any combination thereof. The fat source can further comprise a high melting point fat that has a melting point between about 100° F. to about 110° F. in an amount between about 4.25% to about 20% by weight, which would contribute to the overall total fat content. In one aspect, the high melting point fat can comprise either an animal or vegetable fat, or a combination thereof. Some examples of high melting point fats can be palm oil, palm kernel oil, coconut oil, and hydrogenated soybean oil. Preferably, palm kernel oil can be used. A high-melting point fat is a required component of the total overall fat source.

Without wishing to be bound by theory, it is believed that such high-melting point fat helps maintain the gas cells in the matrix upon cooling. The product is packaged between about 150° F. to about 180° F. and as the product cools, air tries to escape from the air cell matrix. The high-melting point fat appears to trap the air cells during cooling, maintaining its aeration.

The stabilizer system can comprise a hydrocolloid-based stabilizer system provided in a total amount between about 0.5% to about 2.5% by weight. The hydrocolloid-based stabilizer system can comprise a blend of at least two gums, and can further comprise a blend of three or more gums. Additional stabilizers that can be used in the dairy product can comprise carob bean gum, carboxymethyl cellulose (CMC), xanthan gum, methocel, and the like. Where a two gum stabilizer system is used a first gum is gelatin and the second gum is a gum chosen from the group consisting of carob bean gum, carboxymethyl cellulose (CMC), xanthan gum, methocel, and the like; the second gum cannot be carrageenan. Where a three gum stabilizer system is used, the first gum is either gelatin or carrageenan and the remaining gums are selected from the group consisting of carob bean gum, carboxymethyl cellulose (CMC), xanthan gum, methocel, and the like; gelatin and carrageenan cannot be used together. The gums typically provide a thickness to the product at higher temperatures, and can provide a network or structure that can hold air or gas to aid in maintaining the aerated structure. The total amount of gums or stabilizers should not exceed about 2.5%; if the level is too high, the product viscosity becomes too firm (i.e., 3000 Pa or higher). Likewise, if gelatin and carrageenan are used together, the product viscosity becomes too firm.

In one aspect, a two-gum system can be used as the stabilizer. Possible two gum systems for the stabilizer can comprise any two gums from the group mentioned above, as long as one of the gums is gelatin. Thus, blends such as carob gum and gelatin, or CMC and gelatin, and the like, can be used. The gelatin aids in providing the necessary network for maintaining aeration in the two gum system. In another aspect, systems containing three or more gums for the stabilizer can also be used. One of the gums must be either gelatin or carrageenan. For example, CMC, carob gum and gelatin can be combined, or CMC, carob gum, and carrageenan can be combined, and so on. Thus, gelatin is not always necessary in a three or more gum system; in that case, carrageenan, which has a gelatin-like structure, must be used. However, a three gum system should not contain both gelatin and carrageenan. Gelatin (or gelatin-like carrageenan) can maintain air cell structure upon cooling as well as providing a desirable melting characteristic to the product. When carrageenan is used, it is preferred to utilize the Kappa variety of carrageenan, i.e., K-carrageenan. There are three types of carrageenan; Kappa, Iota, and Lambda. K-carrageenan can form firm gels that are similar to gelatin, such that it can be used as a gelatin replacer. Therefore, wherever carrageenan is referenced in the application it should be understood that K-carrageenan is meant.

Without wishing to be bound by theory it is believed that gelatin or a gelatin-like substance, such as carrageenan, is needed to separate the air cells trapped within the matrix as the product cools, especially in a three gum system. Typically, gelatin melts at about 100° F. but below that temperature it provides a rigid structure for the dairy product and keeps the air cells separated after aeration. If the gelatin or carrageenan total drops below a certain amount (i.e., less than about 0.4% for gelatin or less than about 0.1% for carrageenan) then the structure may collapse upon itself and form a dense, non-aerated structure. If a three-gum system does not include gelatin then, as stated above, it should include carrageenan. Furthermore, gelatin provides a number of other beneficial properties to the dairy food product such as increasing the gelling properties of the food product from a weak gel to a firm gel, providing emulsifier and foam stability (i.e., lowers the surface tension of the product enabling air incorporation, and surface active properties allow for a uniform dispersion of air cells), acting as a water binder to prevent water separation during storage, and acting as a texture builder (i.e., contributing to a smooth creamy texture).

In general, all types of gelatin will work as one of the gums of the stabilizer system. For example, both beef-based and pork-based gelatin will work, where these make up the majority of the gelatins. Gelatin typically differs depending on its source, method of manufacture, purity, etc. Any type of gelatin or firmness can be used, but preferably a 200 bloom strength or 240 bloom strength is used. Gelatin or carrageenan used without any other stabilizer would provide a dairy product having a texture that is too firm. The other stabilizers are required (i.e., such as at least one additional gum) to help provide creaminess, texture, and to balance the firming properties that the gelatin or carrageenan contributes. Similarly, if a two-gum system only containing gelatin and carrageenan were made it would also be too firm.

It is preferable when using a two-gum system that about 0.4% to about 1% gelatin based on the total dairy product is used in the formulation, with the second gum comprising approximately the same amount or less. When the second gum comprises greater than the gelatin level, an undesirable product that is chewy and too moist typically can result. Similarly, when a three-gum system is used it is preferable that about 0.4% to about 1% gelatin based on the total dairy product or about 0.1% to about 0.4% carrageenan based on the total dairy product is used, with the balance comprising at least two other gums, up to a total gum content of about 2.5%. Typically, the types of gums used in the blend of the stabilizer system as well as the ratio of the gums used can have an impact on the properties of the final texture of the dairy product.

It is preferable to preblend the stabilizer system before addition to the dairy component mixture. The stabilizer system may be made solely from gums without additional ingredients (i.e., salt or sorbic acid), however, the preblended stabilizer system can also contain, and preferably does contain, other dry additives (i.e., salt or sorbic acid) that can be used in the formulation. It is preferred to add these additional ingredients to the stabilizer system to aid in forming a homogeneous stabilizer system and to aid in dispersing the stabilizer system more completely. Alternatively, the additional ingredients, if any, can be added directly to the dairy mixture rather than the stabilizer system mixture first, however, the stabilizer system may not disperse completely as a result. The stabilizer system may also be directly added to the dairy mixture without being preblended (i.e., gums added separately). However, adding the stabilizer system ingredients individually or in a preblended form without other additional additives may cause clumping, thereby requiring more mixing later and/or higher shear mixing to obtain the desired homogeneous mixture. It is preferable, therefore, to separately mix the stabilizer system and various additional ingredients first (i.e., salt and sorbic acid) and then to add this to the dairy component mixture.

The stabilizer systems can yield hot aerated dairy products that have a similar texture as compared to a cold-aerated cream cheese product without the stabilizer system. In terms of the stabilizer system, it can comprise at least two gums and any additional additives, such that the total amount of gum in the stabilizer system alone in one aspect can comprise from about 55% to about 100%, which is equivalent to about 0.5% to about 2.5% in the total cream cheese product. For instance, in addition to the at least two gums, the stabilizer system may also comprise salt and sorbic acid, and/or other additives. In one aspect, about 0.3% to about 0.6% salt can be added and up to about 0.1% sorbic acid, both based on the total cream cheese product formulation.

The temperature of the resulting mixture is heated to a high temperature, i.e., greater than about 140° F., prior to or at the same time as aeration of the mixture. At a minimum, the temperature should be at least high enough to avoid microbial growth. Typically, the temperature upon aeration is higher than about 150° F. with a maximum temperature of about 180° F. The amount of aeration, or percent overrun, can be about 2 to about 20% overrun, or in particular, it can be from about 2 to about 16% overrun. Typically, less than about 2% overrun is too low to provide a desirable volume increase and texture change. In general, enough air or gas must be supplied in orderto yield a light and airy texture in the dairy product. The gases used to aerate the dairy product can be any that are known in the art, such as nitrogen or air. The percent of cream cheese in the formula can influence the amount of overrun in the finished product. For instance, if greater than about 66% cream cheese is used, the overrun may be too low. Therefore, amounts of cream cheese less than about 66% and greater than about 10% are preferred.

Afterthe aeration step, the resulting hot dairy product can be packaged at its high temperature. The temperature of the aerated dairy product does not need to be cooled, and it is thus hot-filled into the desired packages. Therefore, the temperature upon packaging of the dairy product is also greater than about 140° F., and typically greater than about 150° F. Typically, the packages are hot-filled and packaged at a temperature that is greater than about 150° F. but less than about 180° F. Once the packages are hot-filled, they are hermetically sealed and allowed to cool. Typically, at ambient temperatures, the packaged hot dairy product will cool to about room temperature within about 24 hours. If desired, of course, the product can be cooled faster using conventional techniques. The packaged dairy product can have a shelf life of at least about 3 months, and preferably at least about 12 months when stored at ambient temperatures and at least about 18 months when stored at refrigerated temperatures without requiring aseptic processing or packaging techniques.

Other optional ingredients that may be added can comprise a protein, salt, an acid or base, flavorings, spices, sweeteners, colorants, and the like. Generally, the pH is adjusted to between about 3.7 to about 4.6 pH using any common food-grade acidulant (e.g., citric acid, lactic acid, acetic acid, or hydrochloric acid). A preservative, such as sorbic acid or benzoic acid or their salts, can be added in this pH range.

Various protein sources can also be added to the formulation and can comprise cream cheese, whey protein concentrate, nonfat dry milk, milk protein concentrate, and the like. The whey protein concentrates (WPC) used can comprise many varieties such as WPC 34, WPC 53, and WPC 80. The protein source can be present in an amount between about 3 to about 10 percent by weight. Additionally, a polysaccharide component (e.g., inulin) can be included instead of, or in addition to, a protein source.

The hot viscosity of the final aerated dairy product is generally between about 4 to about 60 Pascal at about 180° F. The cold viscosity of the final dairy product is generally between about 200 to about 1300 Pascal at about room temperature. Furthermore, the water activity of the final product can be about 1.0 and can have a moisture content of about 50 to about 75%, preferably about 50 to about 60%. The product is considered to be a high moisture dairy product.

A method of making an aerated dairy food composition can comprise mixing together about 10 to about 66% of a dairy food base, about 20 to about 30% fat, and about 0.5 to about 2.5% hydrocolloid-based stabilizer system to form a mixture. The mixture can then be aerated to about 2% to about 20% overrun at a temperature of about 140° F. or greater. The aerated dairy food product is then hot-filled into packages at temperatures between about 150° F. and about 180° F., and the packages are hermetically sealed. No aseptic packaging techniques are required. The packaged aerated dairy food product is allowed to cool to provide an organoleptically pleasing, high-moisture, shelf stable, aerated dairy food product.

Turning to FIG. 1, a flow chart is shown generally illustrating the method of this invention. First, optional ingredients such as a protein source can be combined with water and mixed to form a solution. The solution is then combined with cream cheese and mixed to form a cream cheese mixture. The pH of the cream cheese mixture can then be adjusted to about 3.7 to about 4.6. The mixture is then heated between about 140° F. to about 180° F. A fat source is then added to the mixture, which includes a high melting point fat, and the mixture is homogenized. The stabilizer system components are then preblended, and are added to the mixture after homogenization. The mixture is then heated to a temperature greater than 150° F. and held for a time. After heating, the hot mixture is whipped to aerate the mixture. Then, the hot aerated cream cheese product is hot-filled into packages and sealed. The cream cheese is then allowed to cool inside of its sealed package.

The following examples describe and illustrate certain processes to prepare high-moisture, shelf stable, aerated cream cheese products of this invention. These examples are intended to be merely illustrative and not limiting thereof in either scope or spirit. Those skilled in the art will readily understand that variations of the materials, conditions, and processes described in these examples can be used. Unless otherwise noted, all percentages and ratios are by weight.

### EXAMPLE 1

This example illustrates the preparation of a sample formulation used for the makeup of a high-moisture, shelf stable, aerated cream cheese product containing about 54% moisture, about 25% fat, and about 5% protein using a three-gum stabilizer system with gelatin. About 135 grams inulin, about 104 grams of whey protein concentrate 34 (WPC-34) and about 10.95 grams of tricalcium phosphate (TCP) were added to about 502.5 grams of water and mixed slowly for about 5 minutes. The water solution (752.5 g; 60%) was then added to a full fat cream cheese (504 g; 40%), which would result in approximately 34% overall cream cheese in the final product after addition of the stabilizer system. The resulting mixture was then heated to about 100° F. to melt the cream cheese. 5N HCl (about 1%) was used to adjust the pH to about 4.1. The pH-adjusted mixture was then heated to about 140° F. Melted hydrogenated palm oil (about 13.2%) was added to the mixture, and mixed well and then the resulting mixture was homogenized at 3000 psi in a first stage and 500 psi in a second stage (i.e., 3000 psi/500 psi). After the mixture had been homogenized, approximately 1472 grams were weighed and added to a second Thermomix. The homogenized mixture contained about 9.18% inulin, about 7.1% WPC-34, about 0.74% TCP, about 34.19% water, about 34.29% cream cheese, about 1.02% HCl, and about 13.47% palm oil.

The three-gum stabilizer system was prepared; it contained CMC, carob gum, gelatin, sorbic acid, and salt. The dry ingredients were preblended (see Table 1-2). The preblended stabilizer system (about 2.06%) was added to the homogenized mixture (about 97.99%) from above. After mixing for about five minutes, the mixture was heated to about 180° F. and held at that temperature for about 5 minutes. This hot cream cheese slurry was then poured into a Hobart jacketed mixer (Model No. N-50) and aerated by whipping at high speed (i.e., a speed setting of 3) for about 3 minutes at about 150° F. The overrun was about 12.5%. The sample was hot-filled into 8 oz tubs while at above 150° F. and sealed; and the samples were allowed to cool within the tubs.

Table 1-1 below shows the high moisture, shelf stable aerated cream cheese product formulation. The resulting cream cheese product had a hot viscosity of about 4.38 Pa measured at a temperature of about 170° F. to about 180° F. and a cold viscosity of about 1219 Pa measured at about room temperature. The resulting product had a good texture and was light and airy; it retained its overrun and air cell structure for at least about 3 months when stored at room temperature.

TABLE 1-1

| Ingredient | % |
|---|---|
| Full fat cream | 33.6 |
| cheese | |
| Water | 33.5 |
| Hyd. Palm Oil | 13.15 |
| Inulin | 9 |
| WPC-34 | 6.96 |
| TCP | 0.73 |
| 5N HCl | 1 |
| Stabilizer System | 2.06 |

TABLE 1-2

| Ingredient | % |
|---|---|
| CMC | 9.71 |
| Carob gum | 9.71 |
| Gelatin | 48.54 |
| Sorbic Acid | 4.85 |
| Salt | 27.18 |

### EXAMPLE 2

Another sample formulation was used for the makeup of a high-moisture, shelf stable aerated cream cheese product as in Example 1 but comprising a three-gum stabilizer system and containing a higher amount (about 47%) of cream cheese than Example 1. The ingredients with carrageenan used in placed of gelatin and their amounts are shown in Table 2-1. The same method as used in Example 1 was used. The homogenized mixture contained about 9.13% inulin, about 4.39% WPC-34, about 0.72% TCP, about 28.13% water, about 47.68% cream cheese, about 1.12% HCl, and about 8.84% palm oil.

The three-gum stabilizer system was prepared. The stabilizer system in this example contained CMC, carob gum, carrageenan gum (e.g., Kappa-carrageenan), sorbic acid, and salt. The dry ingredients were preblended as shown in Table 2-2. The preblended stabilizer system (about 1.42%) was added to the homogenized mixture (about 98.58%) from above. After mixing for about five minutes, the mixture was heated as in Example 1. An overrun of about 2.70% was obtained. The sample was hot-filled as in Example 1.

Table 2-1 below shows the high moisture, shelf stable aerated cream cheese product formulation. The resulting cream cheese product had a hot viscosity of about 4.38 Pa and a cold viscosity of about 377 Pa, measured at approximately the same temperatures as in Example 1. The resulting product had a good texture and was light and airy; it retained its overrun and air cell structure for at least about 3 months when stored at room temperature.

TABLE 2-1

| Ingredient | % |
|---|---|
| Full fat cream | 47 |
| cheese | |
| Water | 27.73 |
| Hyd. Palm Oil | 8.71 |
| Inulin | 9 |
| WPC-34 | 4.33 |
| TCP | 0.71 |
| 5 N HCl | 1.1 |
| Stabilizer System | 1.42 |

TABLE 2-2

| Ingredient | % |
|---|---|
| CMC | 28.17 |
| Carob gum | 21.13 |
| K-carrageenan gum | 10.56 |
| Sorbic Acid | 7.04 |
| Salt | 33.1 |

### EXAMPLE 3

A similar sample formulation was used for the makeup of a high-moisture, shelf stable aerated cream cheese product as in Example 2, except with a higher level of cream cheese (about 60%) and a higher level of the three gum stabilizer. The ingredients and amounts are shown in Table 3-1. The same method used in Examples 1 and 2 was used. The homogenized mixture contained about 9.12% inulin, about 1.73% WPC-34, about 0.70% TCP, about 22.20% water, about 60.81% cream cheese, about 1.11% HCl, and about 4.33% palm oil.

The three-gum stabilizer system was prepared. The stabilizer system in this example contained CMC, carob gum, carrageenan gum (e.g., K-carrageenan), sorbic acid, and salt. The dry ingredients were preblended as shown in Table 3-2. The preblended stabilizer system (about 1.33%) was added to the homogenized mixture (about 98.67%) from above. After mixing for about five minutes, the mixture was heated as in Example 1. An overrun of about 3.00% was obtained. The sample was hot-filled as in Example 1.

Table 3-1 below shows the high moisture, shelf stable aerated cream cheese product formulation. The resulting cream cheese product had a hot viscosity of about 13 Pa and a cold viscosity of about 465 Pa, measured at approximately the same temperatures as in Example 1. The resulting product had a good texture and was light and airy; it retained its overrun and air cell structure for at least about 3 months when stored at room temperature.

TABLE 3-1

| Ingredient | % |
|---|---|
| Full fat cream | 60 |
| cheese | |
| Water | 21.9 |
| Hyd. Palm Oil | 4.27 |
| Inulin | 9 |
| WPC-34 | 1.71 |
| TCP | 0.69 |
| 5 N HCl | 1.1 |
| Stabilizer System | 1.33 |

TABLE 3-2

| Ingredient | % |
|---|---|
| CMC | 30.08 |
| Carob gum | 22.56 |
| K-carrageenan gum | 11.28 |
| Sorbic Acid | 7.52 |
| Salt | 27.94 |

### COMPARATIVE EXAMPLE 4

A comparative sample product containing about 54% moisture, about 25% fat, and about 5% protein and comprising a three-gum stabilizer system containing neither gelatin or carrageenan. The formulation is shown in Table 4-1; the stabilizer formula is shown in Table 4-2. The same method used in Example 1 was used. The homogenized mixture contained about 9.12% inulin, about 6.0% WPC-34, about 0.69% TCP, about 26.62% water, about 47.65% cream cheese, about 1.12% HCl, and about 8.80% palm oil.

The three-gum stabilizer system was prepared. The stabilizer system in this comparative example contained CMC, carob gum, xanthan gum, sorbic acid, and salt. The dry ingredients were preblended (see Table 4-2). The preblended stabilizer system (about 1.36%) was added to the homogenized mixture (about 98.64%) from above. After mixing for about five minutes, the mixture was heated as in Example 1. An overrun of about 3.46% was obtained. The sample was hot-filled as in Example 1.

Table 4-1 below shows the high moisture cream cheese product formulation. The resulting cream cheese product had a hot viscosity of about 21.9 Pa and a cold viscosity of about 1812 Pa, measured at approximately the same temperatures as in Example 1.

This sample, prepared without either gelatin or carrageenan, had a texture and consistency significantly different from the aerated cream cheese product of the earlier examples. The texture was chewy and rubbery with a leather-like consistency. Although not wishing to be limited by theory, the unacceptable texture was due to a lack of a proper support structure to sustain the desired aerated structure; this was likely due to the lack of either gelatin or carrageenan in the stabilizer system.

TABLE 4-1

| Ingredient | % |
|---|---|
| Full fat cream | 47 |
| cheese | |
| Water | 26.26 |
| Hyd. Palm Oil | 8.68 |
| Inulin | 9 |
| WPC-34 | 5.92 |
| TCP | 0.68 |
| 5 N HCl | 1.1 |
| Stabilizer System | 1.36 |

TABLE 4-2

| Ingredient | % |
|---|---|
| CMC | 29.41 |
| Carob gum | 22.1 |
| Xanthan gum | 8.82 |
| Sorbic Acid | 7.35 |
| Salt | 32.35 |

### EXAMPLE 5

Another sample formulation was used for the makeup of a high-moisture shelf stable aerated cream cheese product as in Example 1 but comprising a two-gum stabilizer system. The ingredients with gelatin and their amounts are shown in Table 5-1. The same method as used in Example 1 was used. The homogenized mixture contained about 9.17% inulin, about 7.09% WPC-34, about 0.74% TCP, about 34.13% water, about 34.44% cream cheese, about 1.02% HCl, and about 13.40% palm oil.

The two-gum stabilizer system was prepared. The stabilizer system in this example contained carob gum, gelatin, sorbic acid, and salt. The dry ingredients were preblended using the amounts shown in Table 5-2. The preblended stabilizer system (about 1.86%) was added to the homogenized mixture (about 98.14%) from above. After mixing for about five minutes, the mixture was heated as in Example 1. An overrun of about 9.8% was obtained. The sample was hot-filled as in Example 1.

Table 5-1 below shows the high moisture, shelf stable aerated cream cheese product formulation. The resulting cream cheese product had a hot viscosity of about 13.16 Pa and a cold viscosity of about 1189 Pas, measured at approximately the same temperatures as in Example 1. The resulting product had a good texture and was light and airy; it retained its overrun and air cell structure for at least about 3 months when stored at room temperature.

TABLE 5-1

| Ingredient | % |
|---|---|
| Full fat cream | 33.8 |
| cheese | |
| Water | 33.5 |
| Hyd. Palm Oil | 13.15 |
| Inulin | 9 |
| WPC-34 | 6.96 |
| TCP | 0.73 |
| 5 N HCl | 1 |
| Stabilizer System | 1.86 |

TABLE 5-2

| Ingredient | % |
|---|---|
| Carob gum | 21.5 |
| Gelatin | 43.01 |
| Sorbic Acid | 5.38 |
| Salt | 30.11 |

### EXAMPLE 6

A sample formulation of a high-moisture shelf stable aerated cream cheese product similar to Example 5 was made except having a higher level of cream cheese (about 60%). The ingredients and amounts are shown in Table 6-1. The same method used in Example 1 was used. The homogenized mixture contained about 9.15% inulin, about 1.74% WPC-34, about 0.70% TCP, about 21.92% water, about 61.03% cream cheese, about 1.12% HCl, and about 4.34% palm oil.

The same ingredients were used for the stabilizer system as in Example 5. The dry ingredients of the stabilizer system were preblended as shown in Table 6-2. The preblended system (about 1.68%) was added to the homogenized mixture (about 98.32%) from above. After mixing for about five minutes, the mixture was heated as in Example 1. An overrun of about 5.8% was obtained. The sample was hot-filled as in Example 5. Table 6-1 below shows the high moisture, shelf stable aerated cream cheese product formulation. The resulting cream cheese product had a hot viscosity of about 26.32 Pa and a cold viscosity of about 1254 Pa, measured at approximately the same temperatures as in Example 5. The resulting sample had a texture and consistency that was similar to the results of Example 5, such that the sample product had a good texture and was light and airy; it retained its overrun and air cell structure for at least about 3 months when stored at room temperature.

TABLE 6-1

| Ingredient | % |
|---|---|
| Full fat cream | 60 |
| cheese | |
| Water | 21.55 |
| Hyd. Palm Oil | 4.27 |
| Inulin | 9 |
| WPC-34 | 1.71 |
| TCP | 0.69 |
| 5 N HCl | 1.1 |
| Stabilizer System | 1.68 |

TABLE 6-2

| Ingredient | % |
|---|---|
| Carob gum | 23.8 |
| Gelatin | 47.62 |
| Sorbic Acid | 5.95 |
| Salt | 22.62 |

### COMPARATIVE EXAMPLE 7

A comparative sample product containing about 54% moisture, about 25% fat, and about 5% protein was made comprising a two-gum stabilizer system with gelatin. The formulation is shown in Table 7-1; stabilizer formulation is shown in Table 7-2. The same method used in Example 1 was used. The homogenized mixture contained about 9.17% inulin, about 7.09% WPC-34, about 0.74% TCP, about 34.13% water, about 34.44% cream cheese, about 1.02% HCl, and about 13.40% palm oil.

The two-gum stabilizer system was prepared. The stabilizer system in this comparative example contained only carob gum, gelatin, sorbic acid, and salt. The dry ingredients were preblended using the amounts shown in Table 7-2. The preblended stabilizer system (about 1.86%) was added to the homogenized mixture (about 98.14%). After mixing for about five minutes, the mixture was heated as in Example 1. An overrun of about 4.7% was obtained. The sample was hot-filled as in Example 1.

Table 7-1 below shows the high moisture cream cheese product formulation. The resulting cream cheese product had a hot viscosity of about 50.46 Pa and a cold viscosity of about 1233 Pa, measured at approximately the same temperatures as in Example 1.

This sample, prepared with a level of the second gum that was higher than the lower level of gelatin, had a texture and consistency significantly different from the aerated cheese product of examples 5 and 6. The texture was chewy and rubbery. The resultant texture did not exhibit desirable characteristics due to the level of the second gum (carob) being higher (i.e., about 0.8% of the total cream cheese product) than the level of gelatin (i.e., about 0.4% of the total cream cheese product) provided.

TABLE 7-1

| Ingredient | % |
|---|---|
| Full fat cream | 33.8 |
| cheese | |
| Water | 33.5 |
| Hyd. Palm Oil | 13.15 |
| Inulin | 9 |
| WPC-34 | 6.96 |
| TCP | 0.73 |
| 5 N HCl | 1 |
| Stabilizer System | 1.86 |

TABLE 7-2

| Ingredient | % |
|---|---|
| Carob gum | 43.01 |
| Gelatin | 21.5 |
| Sorbic Acid | 5.38 |
| Salt | 30.11 |

### EXAMPLE 8

A sample formulation was used for the makeup of a high-moisture shelf stable aerated cream cheese product as in Example 1 but comprising a three-gum stabilizer system without inulin. The ingredients without inulin and their amounts are shown in Table 8-1. The same method as used in Example 1 was used. The homogenized mixture contained 0% inulin, about 16.32% WPC-34, about 0.56% TCP, about 33.48% water, about 35.67% cream cheese, about 1.12% HCl, and about 12.85% palm oil.

The three-gum stabilizer system was prepared. The stabilizer system in this example contained CMC, carob gum, gelatin, sorbic acid, and salt. The dry ingredients were preblended using the amounts shown in Table 8-2. The preblended stabilizer system (about 1.88%) was added to the homogenized mixture (about 98.12%). After mixing for about five minutes, the mixture was heated as in Example 1. An overrun of about 12.8% was obtained. The sample was hot-filled as in Example 1.

Table 8-1 below shows the high moisture, shelf stable aerated cream cheese product formulation. The resulting cream cheese product had a hot viscosity of about 21.93 Pa and a cold viscosity of about 776 Pa, measured at approximately the same temperatures as in Example 1. The resulting sample had a texture and consistency comparable to a high moisture shelf stable aerated cream cheese product made with inulin, such as in Example 1, and had a good texture and was light and airy; it retained its overrun and air cell structure for at least about 3 months when stored at room temperature.

TABLE 8-1

| Ingredient | % |
|---|---|
| Full fat cream | 35 |
| cheese | |
| Water | 32.85 |
| Hyd. Palm Oil | 12.61 |
| Inulin | 0 |
| WPC-34 | 16.01 |
| TCP | 0.55 |
| 5 N HCl | 1.1 |
| Stabilizer System | 1.88 |

TABLE 8-2

| Ingredient | % |
|---|---|
| CMC | 21.28 |
| Carob gum | 10.64 |
| Gelatin | 42.55 |
| Sorbic Acid | 5.32 |
| Salt | 20.21 |

### EXAMPLE 9

A summary table of the results of examples 1-8 is indicated below in Table 9. It is believed that Example 4 had undesirable results because it did not contain either gelatin or carrageenan in its stabilizer system. It is further believed that Example 7 had undesirable results because of the high amount of the second gum (i.e., about 0.8% carob) present in the stabilizer system as compared to the lower amount of gelatin (i.e., about 0.4% of total product). In a desirable two gum system, for example, the first gum is preferably gelatin in a range between about 0.4% to about 1%, with the second gum preferably at a level that is approximately equal to or less than the gelatin amount. For instance, in Example 7, when the level of the second gum was above that of the gelatin amount, the final product became chewy and moist rather than light, dry, and airy as desired. When the second gum remained at a level that was at the gelatin level or below, as in Examples 5 and 6, the desired texture was maintained throughout the product during the storage period tested. Additionally, the types of gums used as the second or third gums can also have an impact on the final texture.

In a three-gum system, the result that did not contain either gelatin or carrageenan had failing results because the stabilizer system did not contain a gum that maintained the air cell matrix. Furthermore, in the three-gum stabilizer system passing results were obtained with either carrageenan or gelatin, however, gelatin is the preferred first gum for the three gum systems.

TABLE 9
Summary of Results of Examples 1-8

| | | | | | | | Gelatin/ | | |
|---|---|---|---|---|---|---|---|---|---|
| | | | | Two | Percent | | K- | | |
| | | Hot | Cold | or | Cream | | Carrageenan | Other Gums | |
| Example | Percent | Viscosity | Viscosity | Three | Cheese | | In Total | In Total | |
| No. | Overrun | (Pa) | (Pa) | gums | Added | Inulin | Product | Product | Evaluation |
| 1 | 12.5 | 4.38 | 1219 | 3 | 34% | Yes | 1% gelatin | CMC (0.2%); | Good |
| | | | | | | | | Carob | |
| | | | | | | | | (0.2%) | |
| 2 | 2.7 | 4.38 | 377 | 3 | 47% | Yes | 0.15% K- | CMC (0.4%); | Good |
| | | | | | | | Carrageenan | Carob | |
| | | | | | | | | (0.3%) | |
| 3 | 3 | 13 | 465 | 3 | 60% | Yes | 0.15% K- | CMC (0.4%); | Good |
| | | | | | | | Carrageenan | Carob | |
| | | | | | | | | (0.3%) | |
| Comparative 4 | 3.46 | 21.9 | 1812 | 3 | 47% | Yes | Neither | CMC (0.4%); | Unacceptable |
| | | | | | | | | Carob | |
| | | | | | | | | (0.3%); | |
| | | | | | | | | Xanthan | |
| | | | | | | | | (0.12%) | |
| 5 | 9.8 | 13.16 | 1189 | 2 | 34% | Yes | 0.8% gelatin | Carob | Good |
| | | | | | | | | (0.4%) | |
| 6 | 5.8 | 26.32 | 1254 | 2 | 60% | Yes | 0.8% gelatin | Carob | Good |
| | | | | | | | | (0.4%) | |
| Comparative 7 | 4.7 | 50.46 | 1233 | 2 | 34% | Yes | 0.4% gelatin | Carob | Unacceptable |
| | | | | | | | | (0.8%) | |
| 8 | 12.8 | 21.93 | 776 | 3 | 35% | No | 0.8% gelatin | CMC (0.4%); | Good |
| | | | | | | | | Carob | |
| | | | | | | | | (0.2%) | |

What is claimed is:

1. An aerated food composition comprising a dairy food base, a fat source at least partially comprising a high-melting point fat, and a hydrocolloid-based stabilizer system in an amount effective to provide an organoleptically-pleasing, high-moisture shelf stable, hot-temperature aerated dairy food product;
wherein the dairy food product is aerated at a sufficient temperature for microstability and subsequently hot-filled into packages while maintaining its aerated structure;
wherein the hydrocolloid-based system comprises at least two gums where one of the gums is gelatin or at least three gums where one of the gums is gelatin or carrageenan; and
wherein the dairy food product has a shelf life of at least three months at ambient temperature.

2. The aerated food composition as defined in claim 1, wherein the hydrocolloid-based stabilizer system comprises two gums, one gum is gelatin and the second gum is selected from the group consisting of carboxy methyl cellulose, carob bean gum, xanthan gum, and methocel.

3. The aerated food composition as defined in claim 2, wherein the gelatin comprises from about 0.4% to about 1% of the final dairy food product.

4. The aerated food composition as defined in claim 2, wherein the carrageenan comprises from about 0.1% to about 0.4% of the final dairy food product.

5. The aerated food composition as defined in claim 1, wherein the hydrocolloid-based stabilizer system comprises at least three gums, one gum is either gelatin or carrageenan and the other gums are selected from the group consisting of carboxy methyl cellulose, carob bean gum, xanthan gum, and methocel.

6. The aerated food composition as defined in claim 1, further comprising from about 10% to about 66% of the dairy food base, from about 20 to about 30% of the fat source, and from about 0.5 to about 2.5% of the hydrocolloid-based stabilizer system.

7. The aerated food composition as defined in claim 1, wherein the fat source comprises the high melting point fat from about 4.25% to about 20% of the total fat and is selected from the group consisting of palm oil, coconut oil, hydrogenated soybean oil, palm kernel oil, and low fat cream cheese.

8. The aerated food composition as defined in claim 1, wherein an aeration of the food composition is between about 2% to about 20% aeration and at a temperature greater than about 150° F.

9. The aerated food composition as defined in claim 8, wherein the aeration is between about 2% to about 16% overrun.

10. The aerated food composition as defined in claim 1, wherein the aerated food composition is filled and packaged at a final temperature greater than about 150° F. but less than about 180° F.

11. A method of making an aerated dairy food composition, the method comprising:
mixing about 10% to about 66% dairy food base, about 20% to about 30% fat where between about 4.25% to about 20% of the total fat includes a high melting point fat, and about 0.5% to about 2.5% of a stabilizer system comprising at least two gums, together to form a mixture;
aerating the mixture to an aeration level of about 2% to about 20% overrun at a temperature of at least about 150° F.;
hot-filling packages with the aerated dairy food product at temperatures between about 150° F. to about 180° F.;
sealing the packages with a hermetic seal after filling; and
cooling the aerated dairy food product while in the package to provide an organoleptically-pleasing, high-moisture aerated dairy food product having shelf stability of at least three months at ambient temperature.

12. The method of claim 11, wherein the stabilizer system comprises two gums, a first gum being gelatin and a second gum is selected from the group consisting of carboxy methyl cellulose, carob bean gum, xanthan gum, and methocel.

13. The method of claim 12, wherein the gelatin comprises from about 0.4% to about 1% of the final dairy food product.

14. The method of claim 12, wherein the carrageenan comprises from about 0.1% to about 0.4% of the final dairy food product.

15. The method of claim 11, wherein the stabilizer system comprises at least three gums, a first gum being either gelatin or carrageenan and a second and third gum is selected from the group consisting of carboxy methyl cellulose, carob bean gum, xanthan gum, and methocel.

16. The method of claim 11, further comprising aerating the mixture with either air or nitrogen.

17. The method of claim 11, wherein the aerated dairy food product has a cold viscosity of about 200 to about 1300 Pascal at about room temperature and a hot viscosity of about 4 to about 60 Pascal at the final temperature.

18. The method of claim 11, wherein the dairy food base is cream cheese.

19. The method of claim 11, wherein the aerated mixture has a pH of about 3.7 to about 4.6.

20. A shelf stable, high moisture, aerated dairy product comprising a mixture of about 10 to about 66 percent of a cream cheese product, about 20 to about 30 percent fat comprising about 4.25 to about 20 percent of a high melting point fat, and about 0.5 to about 2.5 percent of a hydrocolloid-based stabilizer system comprising at least two gums;
wherein the mixture has a pH of about 3.7 to about 4.6;
wherein the high melting point fat has a melting point between about 100° F. to about 110° F. and is an animal fat or a vegetable fat;
wherein the hydrocolloid-based stabilizer system comprises at least two gums where one gum is gelatin and the other gum is selected from the group consisting of carboxy methyl cellulose, carob bean gum, xanthan gum, and methocel, or at least three gums where one of the gums is gelatin or carrageenan and the other gums are selected from the group above;
wherein the mixture is aerated and hot filled at temperatures greater than about 150° F. to produce the dairy product;
wherein the dairy product has a moisture content of about 50 to about 75 percent;
wherein the dairy product has an overrun of about 2 to about 20 percent; and
wherein the dairy product has a shelf life of at least 12 months when stored at ambient temperatures or at least 18 months when stored at refrigeration temperatures without requiring aseptic processing or packaging techniques.
